(19) United States
(12) Patent Application Publication
(10) Pub. No.: US 2026/0131630 A1
(43) Pub. Date: May 14, 2026

(54) CONTROL METHOD OF HEAT PUMP SYSTEM FOR VEHICLE

(71) Applicants: Hyundai Motor Company, Seoul (KR); Kia Corporation, Seoul (KR)

(72) Inventor: Seong-Bin JEONG, Hwaseong-SI (KR)

(73) Assignees: Hyundai Motor Company, Seoul (KR); Kia Corporation, Seoul (KR)

(21) Appl. No.: 19/227,275

(22) Filed: Jun. 3, 2025

(30) Foreign Application Priority Data
Nov. 11, 2024 (KR) 10-2024-0159181

(51) Int. Cl. B60H 1/00

(52) U.S. Cl. CPC B60H 1/00899; B60H 1/00278

(57) ABSTRACT

A control method of a heat pump system for a vehicle is provided to improve the heating efficiency by efficiently recollecting the thermal energy generated at the battery while adjusting the temperature of a battery.

### CROSS-REFERENCE TO RELATED APPLICATION

The present application claims priority to and the benefit of Korean Patent Application No. 10-2024-0159181 filed with the Korean Intellectual Property Office on Nov. 11, 2024, the entire contents of which is incorporated herein by reference.

### BACKGROUND OF THE INVENTION

### Field of the Present Disclosure

The present disclosure relates to a control method of a heat pump system for a vehicle, and more particularly, the present disclosure relates to a control method of a heat pump system for a vehicle capable of improving the heating efficiency by controlling the temperature of a battery and at the same time, by efficiently recollecting the thermal energy generated at a battery.

### Description of the Related Art

Generally, an air conditioning system for a vehicle includes an air conditioner unit circulating a refrigerant to heat or cool an interior of the vehicle.

The air conditioner unit, which is to maintain the interior of the vehicle at an appropriate temperature regardless of a change in an external temperature to maintain a comfortable internal environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

That is, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

Meanwhile, recently, in accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In the electric vehicle or the hybrid vehicle among these environment-friendly vehicles, a separate heater is not used unlike an air conditioner of a general vehicle, and an air conditioner used in the environment-friendly vehicle is generally called a heat pump system.

Meanwhile, since a large amount of heat is generated in the battery and the driving motor used as a primary power source of the electric vehicle, as well as the electrical components, efficient cooling is required, so efficient temperature management of the electrical components and the battery may be a very important problem.

Furthermore, since a battery performs optimally at a preset temperature, it needs to be rapidly heated up to the preset temperature in the early stage of driving.

Conventionally, separate cooling systems are applied to adjust the temperature of the electrical components and the battery, but it is necessary to increase capacity of the cooling system according thereto, which leads to space restrictions. Further, when the capacity of the cooling systems is increased, power required for operating the cooling systems is also increased.

Furthermore, conventionally, when cooling of the battery is required at the time of heating the vehicle interior, the heat pump system needs to be switched to a mode for cooling the battery by using the coolant heat-exchanged with the refrigerant even if the waste heat of the battery is sufficient, which causes decrease of the power consumption efficiency and heating performance.

Furthermore, when switching from the heating mode to a mode for cooling the battery by using the coolant heat-exchanged with the refrigerant for cooling of the battery, a delay time is caused due to the stopping of the operation of the compressor, so that the cooling of the battery is temporarily interrupted, which causes the efficient temperature management of the battery to become difficult.

Accordingly, to prevent a decrease in power consumption efficiency in electric vehicles, secure battery durability, and maximize energy efficiency, technology development is required to control battery temperature and efficiently use the waste heat generated at the battery.

The above information disclosed in this Background section is only for enhancement of understanding of the background of the disclosure, and therefore it may contain information that does not form the prior art that is already known in this country to a person of ordinary skill in the art.

### SUMMARY OF THE INVENTION

The present disclosure attempts to provide a control method of a heat pump system for a vehicle configured for improving the heating efficiency by efficiently recollecting the thermal energy generated at the battery while adjusting the temperature of a battery.

A control method of a heat pump system for a vehicle, including procedures of (A) when a user operates a heating mode for heating a vehicle interior, circulating, by a controller, a coolant to an electrical component and a chiller, determine, by the controller, whether a temperature of a battery is higher than or equal to a first predetermined temperature based on data detected from a data detecting unit while controlling an operation of a heat pump system, (B) when it is determined through the procedure (A) that the temperature of the battery is higher than or equal to the first predetermined temperature, determining, by the controller, a discharge pressure of a compressor, an amount of change in the discharge pressure of the compressor, and a vehicle internal temperature while circulating the coolant to the battery and the chiller and maintaining the heating mode, and controlling an operation of a cooling fan and the heat pump system, (C) after performing the procedure (B), determining, by the controller, the temperature of a battery change amount, and circulating the coolant to a radiator and the battery, and (D) after performing the procedure (C), controlling, by the controller, the operation of the cooling fan and the heat pump system while circulating the coolant to the battery and the chiller by determining whether the temperature of the battery is higher than a second predetermined temperature based on data detected from the data detecting unit, and controlling the compressor by determining whether the temperature of the battery is higher than a third predetermined temperature, and determine whether the temperature of the battery is lower than the first predetermined temperature.

The procedure (A) may include operating the heating mode by the controller, when the user operates the heat pump system for heating the vehicle interior, connecting, by the controller, the electrical component and the chiller, and controlling the operation of the heat pump system by using at least two lines through which the coolant flows, and determining, by the controller, whether the temperature of the battery is higher than or equal to the first predetermined temperature based on data detected from the data detecting unit.

In the connecting, by the controller, the electrical component and the chiller, and controlling the operation of the heat pump system by using at least two lines through which the coolant flows, the controller may be configured to control a first expansion valve to be closed so that a refrigerant is not supplied to an evaporator, control a second expansion valve to be opened so that the unexpanded refrigerant is supplied to the chiller, control a third expansion valve to be opened to perform expansion so that the expanded refrigerant may be supplied to a heat-exchanger, and operate the compressor at a maximum rotation speed (RPM).

When it is determined that the temperature of the battery is lower than the first predetermined temperature (i.e., when the condition is not satisfied) in the determining of whether the temperature of the battery is higher than or equal to the first predetermined temperature, the method may return to the connecting the electrical component and the chiller, and controlling the operation of the heat pump system by using at least two lines through which the coolant flows.

When it is determined that the temperature of the battery is higher than or equal to the first predetermined temperature (i.e., the condition is satisfied) in the determining of whether the temperature of the battery is higher than or equal to the first predetermined temperature, the procedure (B) may be performed.

The procedure (B) may include connecting, by the controller, the battery and the chiller by using at least two lines through which the coolant flows, determining, by the controller, whether the discharge pressure of the compressor is greater than a predetermined pressure based on data detected from the data detecting unit, increasing, by the controller, an opening of a third expansion valve operated to be opened to perform expansion, when it is determined that the discharge pressure of the compressor is greater than the predetermined pressure (i.e., the condition is satisfied) in the determining of whether the discharge pressure of the compressor is greater than the predetermined pressure, determining, by the controller, whether the amount of change in the discharge pressure of the compressor is greater than 0 based on data detected from the data detecting unit, decreasing, by the controller, a rotation speed of the compressor, when it is determined that the amount of change in the discharge pressure of the compressor is greater than 0 (i.e., the condition is satisfied) in the determining of whether the amount of change in the discharge pressure of the compressor is greater than 0, determining, by the controller, whether the vehicle internal temperature is higher than a predetermined target temperature based on data detected from the data detecting unit, and controlling, by the controller, the cooling fan and controlling the heat pump system so that the usage of the heat pump system may be minimized, when it is determined that the vehicle internal temperature is higher than the target temperature (i.e., the condition is satisfied) in the determining of whether the vehicle internal temperature is higher than the target temperature.

When it is determined that the discharge pressure of the compressor is smaller than the predetermined pressure (i.e., when the condition is not satisfied) in the determining of whether the discharge pressure of the compressor is greater than the predetermined pressure, the method may return to the connecting, by the controller, the battery and the chiller by using at least two lines through which the coolant flows.

When it is determined that the amount of change in the discharge pressure of the compressor is smaller than 0 (i.e., when the condition is not satisfied) in the determining of whether the amount of change in the discharge pressure of the compressor is greater than 0, the method may return to the increasing, by the controller, the opening of the third expansion valve operated to be opened to perform expansion.

In the determining of whether the vehicle internal temperature is higher than the target temperature, when it is determined that the vehicle internal temperature is lower than the target temperature (i.e., when the condition is not satisfied), the method may return to the decreasing, by the controller, the rotation speed of the compressor.

In the controlling, by the controller, the cooling fan and controlling the heat pump system so that the usage of the heat pump system may be minimized, the controller may be configured to operate the compressor at a minimum rotation speed, decrease a rotation speed of the cooling fan, and decrease a rotation speed of a corresponding water pump so that the flow rate of the coolant circulating through the battery and the chiller is decreased.

The procedure (C) may include determining, by the controller, whether the temperature of a battery change amount is higher than 0° C. based on data detected from the data detecting unit, and connecting, by the controller, the radiator and the battery by using at least two lines through which the coolant flows, when it is determined that the temperature of a battery change amount is higher than 0° C. (i.e., the condition is satisfied) in the determining of whether the temperature of a battery change amount is higher than 0° C.

When it is determined that the temperature of a battery change amount is lower than 0° C. (i.e., when the condition is not satisfied) in the determining of whether the temperature change amount of a battery is higher than 0° C., the method may return to the connecting, by the controller, the battery and the chiller by using at least two lines through which the coolant flows, in the procedure (B).

The procedure (D) may include determining, by the controller, whether the temperature of the battery is higher than the second predetermined temperature based on data detected from the data detecting unit, connecting, by the controller, the battery and the chiller, and controlling the operation of the cooling fan and the heat pump system by using at least two lines through which the coolant flows, when it is determined that the temperature of the battery is higher than the second predetermined temperature (i.e., the condition is satisfied) in the determining of whether the temperature of the battery is higher than the second predetermined temperature, determining, by the controller, whether the temperature of the battery is higher than the third predetermined temperature based on data detected from the data detecting unit, increasing, by the controller, the rotation speed of the compressor introduced into the HVAC module 12, when it is determined that the temperature of the battery is higher than the third predetermined temperature (i.e., the condition is satisfied) in the determining of whether the temperature of the battery is higher than the third predetermined temperature, determining, by the controller, whether the temperature of the battery is lower than the first predetermined temperature based on data detected from the data detecting unit, and terminating the control by the controller, when it is determined that the temperature of the battery is lower than the first predetermined temperature (i.e., the condition is satisfied) in the determining of whether the temperature of the battery is lower than the first predetermined temperature.

When it is determined that the temperature of the battery is lower than the second predetermined temperature (i.e., when the condition is not satisfied) in the determining of whether the temperature of the battery is higher than the second predetermined temperature, the method may return to the connecting, by the controller, the radiator and the battery by using at least two lines through which the coolant flows, in the procedure (C).

In the connecting the battery and the chiller, and controlling the operation of the cooling fan and the heat pump system by using at least two lines through which the coolant flows, the controller may be configured to control a first expansion valve to be closed so that a refrigerant is not supplied to an evaporator, control a second expansion valve to be opened to perform expansion so that the expanded refrigerant may be supplied to the chiller, control the third expansion valve to be opened so that the unexpanded refrigerant is supplied to a heat-exchanger, and increase a rotation speed of the cooling fan.

When it is determined that the temperature of the battery is lower than the third predetermined temperature (i.e., when the condition is not satisfied) in the determining of whether the temperature of the battery is higher than the third predetermined temperature, the method may return to the connecting, by the controller, the battery and the chiller, and controlling the operation of the cooling fan and the heat pump system by using at least two lines through which the coolant flows.

When it is determined that the temperature of the battery is higher than the first predetermined temperature (i.e., when the condition is not satisfied) in the determining of whether the temperature of the battery is lower than the first predetermined temperature, the method may return to the increasing, by the controller, the rotation speed of the compressor introduced into the HVAC module 12.

The data detecting unit may include a battery temperature sensor configured for measuring the temperature of the battery, a pressure sensor configured for measuring a pressure of a refrigerant discharged from the compressor (i.e., the discharge pressure of the compressor), and a vehicle internal temperature sensor configured for measuring a temperature of the vehicle interior.

The controller may be electrically connected to the heat pump system, and the heat pump system may include the compressor configured to compress an introduced refrigerant, a Heating, Ventilation, and Air Conditioning (HVAC) module in which an internal condenser and an evaporator connected to the compressor through a refrigerant line are provided, a heat-exchanger connected to the internal condenser through the refrigerant line, and configured to condense or evaporate the refrigerant supplied from the internal condenser by heat-exchanging with an air, a first expansion valve provided on the refrigerant line between the heat-exchanger and the evaporator, a refrigerant connection line disposed between the compressor and the evaporator and including a first end portion connected to the refrigerant line, and a second end portion connected to the refrigerant line between the heat-exchanger and the first expansion valve, the chiller provided on the refrigerant connection line, and configured to heat-exchange the refrigerant introduced through the refrigerant connection line with the selectively introduced coolant to adjust a temperature of the coolant, a second expansion valve provided on the refrigerant connection line at an upstream end portion of the chiller, and a third expansion valve provided on the refrigerant line between the internal condenser and the heat-exchanger.

The controller may be electrically connected to a cooling apparatus configured to circulate the coolant, and the cooling apparatus may include a valve module configured to control a flow direction of the internally introduced coolant, a first line connected to the valve module to selectively flow the coolant, and on which the electrical component is provided, a second line including a first end portion connected to the first line and a second end portion connected to the valve module to selectively flow the coolant, and on which the radiator is provided, a third line connected to the valve module to selectively flow the coolant, and on which the battery is provided, a fourth line including a first end portion connected to the valve module to selectively flow the coolant, and a second end portion connected to the third line, a fifth line including a first end portion connected to the valve module to selectively flow the coolant, and including a second end portion at which the chiller is provided, a sixth line including a first end portion connected to the first line at a position where the first line and the second line are connected, and a second end portion connected to the chiller to selectively flow the coolant, and a seventh line including a first end portion connected to the third line at a position where the third line and the fourth line are connected, and a second end portion connected to the chiller to selectively flow the coolant.

As described above, according to a control method of a heat pump system for a vehicle according to an embodiment, the heating efficiency may be improved by efficiently recollecting the thermal energy generated at the battery while adjusting the temperature of a battery.

Furthermore, according to the present disclosure, heating of the vehicle interior may be preferentially performed by using the maximum waste heat of the battery in the usable region of the heat pump, and by switching to a mode for cooling by using the coolant cooled at the radiator or cooling by using the coolant heat-exchanged with the refrigerant depending on the temperature of a battery, the power consumption efficiency may be prevented from being lowered, and the overall heating performance may be improved.

Furthermore, according to the present disclosure, when switching, for cooling of the battery, from the heating mode to a mode for cool by using the coolant heat-exchanged with the refrigerant, the mode switching is possible through an operation control of respective expansion valves without stopping the operation of the compressor, preventing occurrence of the delay time due to mode switching, and more efficiently managing the temperature of a battery.

Furthermore, according to the present disclosure, by efficiently adjusting the temperature of a battery, the optimal performance of the battery may be achieved, and the overall travel distance of the vehicle may be increased through efficient management of the battery.

### BRIEF DESCRIPTION OF THE DRAWINGS

FIG. 1 is a block diagram of a heat pump system to which a control method of a heat pump system for a vehicle according to an embodiment is applied.

FIG. 2 is a block diagram showing a heat pump system control apparatus to which a control method of a heat pump system for a vehicle according to an embodiment is applied.

FIG. 3A and FIG. 3B are control flowcharts for explaining a control method of a heat pump system for a vehicle according to an embodiment.

### DETAILED DESCRIPTION OF THE EMBODIMENTS

An embodiment will hereinafter be described in detail with reference to the accompanying drawings.

Exemplary embodiments disclosed in the present specification and the constructions depicted in the drawings are only the preferred embodiments of the present disclosure, and do not cover the entire scope of the present disclosure. Therefore, it will be understood that there may be various equivalents and variations at the time of the application of the present specification.

In order to clarify the present disclosure, parts that are not related to the description will be omitted, and the same elements or equivalents are referred to with the same reference numerals throughout the specification.

Also, the size and thickness of each element are arbitrarily shown in the drawings, but the present disclosure is not necessarily limited thereto, and in the drawings, the thickness of layers, films, panels, regions, etc., are exaggerated for clarity.

Furthermore, unless explicitly described to the contrary, the word “comprise” and variations such as “comprises” or “comprising”, will be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation.

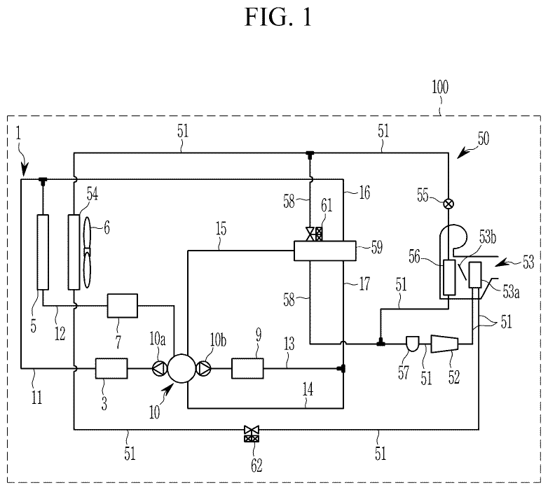

FIG. 1 is a block diagram of a heat pump system for a vehicle according to an embodiment.

Referring to FIG. 1, a control method of a heat pump system for a vehicle according to an embodiment may be controlled by a controller 100, and may be applied to an electric vehicle or hybrid vehicle to which a heat pump system 50 is applied, to improve the heating efficiency by efficiently recollecting the thermal energy generated at the battery 9 while controlling the temperature of the battery 9.

Here, as shown in FIG. 1, the heat pump system 50 may be linked with a cooling apparatus 1.

First, the cooling apparatus 1 may include a valve module 10, a first line 11, a second line 12, a third line 13, a fourth line 14, a fifth line 15, a sixth line 16, and a seventh line 17.

The valve module 10 may be configured for controlling a flow direction of an internally introduced coolant by a control signal of the controller 100.

In the exemplary embodiment, a first end portion of the first line 11 may be connected to the valve module 10, and may selectively flow the coolant. an electrical component 3 may be provided on the first line 11.

A first end portion of the second line 12 may be connected to a second end portion of the first line 11. A second end portion of the second line 12 may be connected to the valve module 10, and may selectively flow the coolant.

A radiator 5 and a reservoir tank 7 may be provided on the second line 12. The radiator 5 may be disposed at a front of the vehicle. A cooling fan 6 may be provided at a rear of the radiator 5.

Accordingly, the radiator 5 may cool the coolant through an operation of the cooling fan 6 and heat-exchange with an ambient air.

In the exemplary embodiment, a first end portion of the third line 13 may be connected to the valve module 10 to selectively flow the coolant. The battery 9 may be provided on the third line 13.

A first end portion of the fourth line 14 may be connected to the valve module 10 to selectively flow the coolant. A second end portion of the fourth line 14 may be connected to a second end portion of the third line 13.

In the exemplary embodiment, a first end portion of the fifth line 15 may be connected to the valve module 10 to selectively flow the coolant. A chiller 59 may be provided on a second end portion of the fifth line 15.

Here, the chiller 59 may be connected to a refrigerant line 51 of the heat pump system 50 through a refrigerant connection line 58. The chiller 59 may be a water-cooled heat-exchanger configured to heat-exchange the internally introduced coolant with the refrigerant supplied from the heat pump system 50.

That is, the chiller 59 may adjust a temperature of the coolant by heat-exchanging the selectively supplied coolant with the refrigerant selectively supplied from the heat pump system 50.

Here, the chiller 59 may be operated when the battery 9 is to be cooled by using the coolant heat-exchanged with the refrigerant, or to recollect the heat from the coolant having been heated by the waste heat of the electrical component 3 or the waste heat of the battery 9 when heating the vehicle interior.

A first end portion of the sixth line 16 may be connected to the first line 11 at a position where the first line 11 and the second line 12 are connected. A second end portion of the sixth line 16 may be connected to the chiller 59, and the coolant may selectively flow therethrough according to an operation of the valve module 10.

In addition, a first end portion of the seventh line 17 may be connected to the third line 13 at a position where the third line 13 and the fourth line 14 are connected. A second end portion of the seventh line 17 may be connected to the chiller 59.

The coolant may selectively flow through the seventh line 17 configured as such according to the operation of the valve module 10.

Meanwhile, in an exemplary embodiment of the present disclosure, the valve module 10 may include at least one water pump. Here, the at least one water pump may include first and second water pumps 10a, and 10b.

First, the first water pump 10a may be mounted on the valve module 10 to correspond to the first line 11. Furthermore, the second water pump 10b may be mounted on the valve module 10 to correspond to the third line 13.

Here, the first water pump 10a and the second water pump 10b may be disposed at locations facing each other based on the valve module 10.

The cooling apparatus 1 configured as such may be electrically connected to the controller 100, and may be operated according to the control signal of the controller 100.

In addition, the heat pump system 50 may include a compressor 52, an HVAC module 53, a heat-exchanger 54, a first expansion valve 55, an accumulator 57, the refrigerant connection line 58, the chiller 59, a second expansion valve 61, and a third expansion valve 62.

First, the compressor 52 may compress the introduced refrigerant and flow the compressed refrigerant to the refrigerant line 51 so that the refrigerant is circulated along the refrigerant line 51.

An internal condenser 53a and an evaporator 56 connected through the refrigerant line 51 may be provided inside the HVAC module 53.

Here, the opening/closing door 53b configured to adjust the ambient air having passed through the evaporator 56 to be selectively introduced into the internal condenser 53a may be provided inside the HVAC module 53 between the evaporator 56 and the internal condenser 53a.

When heating the vehicle interior, the opening/closing door 53b may be opened so that the ambient air having passed through the evaporator 56 is introduced into the internal condenser 53a.

That is, the high-temperature refrigerant supplied to the internal condenser 53a may increase a temperature of the ambient air passing through the internal condenser 53a. That is, the introduced ambient air may be converted to a high-temperature state while passing through the internal condenser 53a and then introduced into the vehicle interior, implementing heating of the vehicle interior.

To the contrary, when cooling the vehicle interior, the opening/closing door 53b may close a side toward the internal condenser 53a so that the ambient air cooled while passing through the evaporator 56 is directly introduced into the vehicle interior.

Accordingly, the ambient air passing through the evaporator 56 may be cooled while passing through the evaporator 56 by the low-temperature refrigerant supplied to the evaporator 56. The cooled ambient air may be introduced into the vehicle interior, cooling the vehicle interior.

The heat-exchanger 54 may be connected to the internal condenser 53 a through the refrigerant line 51. The heat-exchanger 54 may be disposed at the front of the vehicle. The heat-exchanger 54 may be disposed between the radiator 5 and the cooling fan 6.

That is, the heat-exchanger 54 may be an air-cooled heat-exchanger configured to heat-exchange the introduced refrigerant with the ambient air.

In the exemplary embodiment, the first expansion valve 55 may be provided on the refrigerant line 51 connecting the heat-exchanger 54 and the evaporator 56. The first expansion valve 55 may selectively expand the introduced refrigerant.

Here, the heat pump system may further include the accumulator 57 provided on the refrigerant line 51 between the evaporator 56 and the compressor 52. The accumulator 57 may improve the efficiency and durability of the compressor 52 by supplying only the gaseous refrigerant to the compressor 52.

A first end portion of the refrigerant connection line 58 may be connected to the refrigerant line 51 between the evaporator 56 and the accumulator 57. A second end portion of the refrigerant connection line 58 may be connected to the refrigerant line 51 between the heat-exchanger 54 and the first expansion valve 55.

The chiller 59 may be provided on the refrigerant connection line 58. The chiller 59 may adjust the temperature of the coolant by heat-exchanging the refrigerant introduced through the refrigerant connection line 58 with the coolant selectively introduced from the cooling apparatus 1.

In the exemplary embodiment, the second expansion valve 61 may be provided on the refrigerant connection line 58 at an upstream end portion of the chiller 59. The second expansion valve 61 may be an electronic expansion valve configured to selectively expand the refrigerant while controlling the flow direction of the supplied refrigerant.

Here, the upstream end portion and a downstream end portion of the chiller 59 may be set based on a flow direction of the refrigerant. Based on the direction in which the refrigerant flows along the refrigerant connection line 58, a location where the refrigerant is introduced into the chiller 59 may be defined as an upstream end portion of the chiller 59, and a location where the refrigerant is discharged from the chiller 59 may be defined as a downstream end portion of the chiller 59.

Furthermore, the third expansion valve 62 may be provided on the refrigerant line 51 between the internal condenser 53 a and the heat-exchanger 54. The third expansion valve 62 may be an electronic expansion valve configured to selectively expand the refrigerant while controlling the flow direction of the supplied refrigerant.

Meanwhile, the heat-exchanger 54 may condense or evaporate the refrigerant through heat-exchange with the ambient air according to a selective operation of the third expansion valve 62.

That is, when cooling the vehicle interior, when the unexpanded refrigerant is introduced by operation of the third expansion valve 62, the heat-exchanger 54 may condense the refrigerant while heat-exchanging it with the ambient air.

To the contrary, when heating the vehicle interior, when the refrigerant expanded by operation of the third expansion valve 62 is introduced, the heat-exchanger 54 may recollect the ambient air heat while heat-exchanging the refrigerant with the ambient air.

The heat pump system 50 configured as such may be electrically connected to the controller 100.

That is, the cooling apparatus 1 and the heat pump system 50 may be linked through the chiller 59.

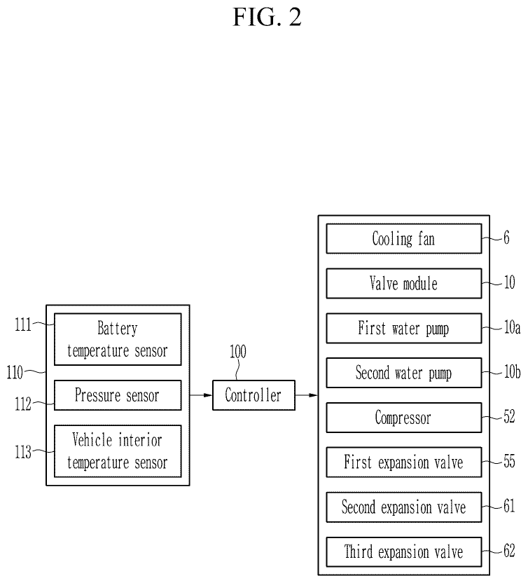

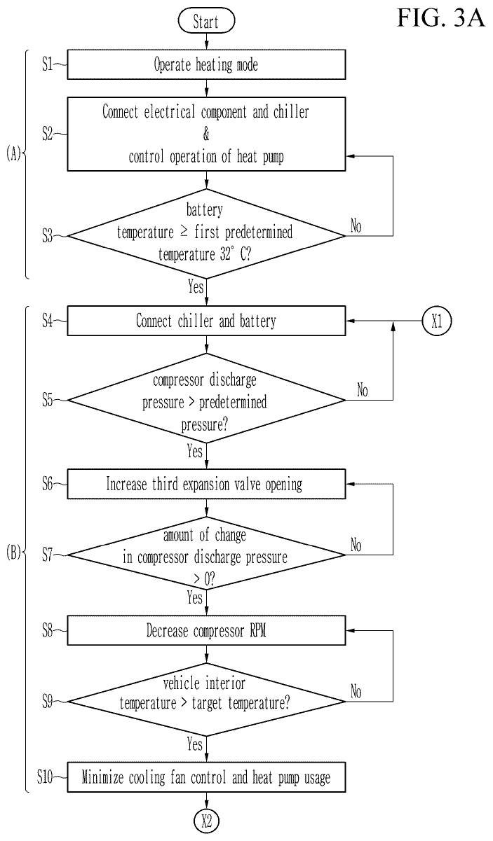

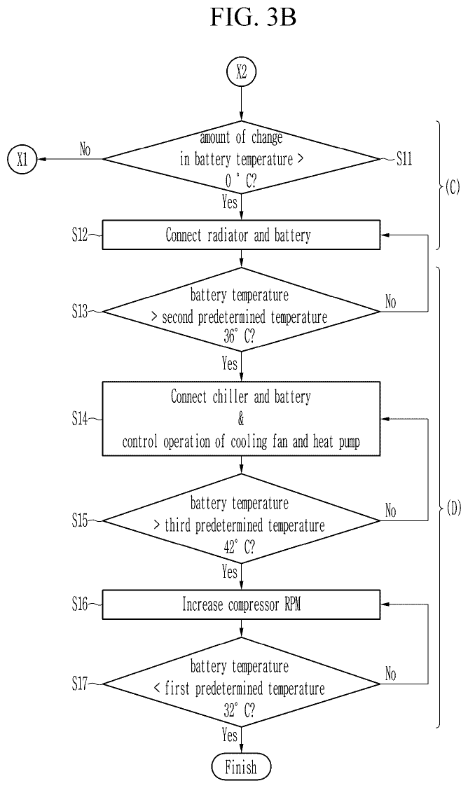

Hereinafter, a control method of a heat pump system for a vehicle configured as described above will be described with reference to FIG. 2, FIG. 3A, and FIG. 3B.

FIG. 2 is a block diagram showing a heat pump system control apparatus to which a control method of a heat pump system for a vehicle according to an embodiment is applied, and FIG. 3 is a control flowchart for explaining a control method of a heat pump system for a vehicle according to an embodiment.

As shown in FIG. 2, the cooling apparatus 1 and the heat pump system 50 may be controlled by a heat pump system control apparatus, and the heat pump system control apparatus may include the controller 100 and data detecting unit 110.

In an exemplary embodiment of the present disclosure, the data detecting unit 110 may detect data for the controller 100 to control an operation of the cooling apparatus 1 and the heat pump system 50.

The data detected by the data detecting unit 110 may be transferred to the controller 100. The data detecting unit 110 may include a battery temperature sensor 111, a pressure sensor 112, and a vehicle internal temperature sensor 113.

First, the battery temperature sensor 111 may measure a temperature of the battery 9. That is, the battery temperature sensor 111 may measure the temperature of the battery 9, and may transfer relevant signals to the controller 100.

The pressure sensor 112 may measure a pressure of the refrigerant discharged from the compressor 52 (a discharge pressure of the compressor 52). The pressure sensor 112 may measure a compressor discharge pressure, and may transfer relevant signals to the controller 100.

Furthermore, the vehicle internal temperature sensor 113 may be provided in the vehicle interior. It may measure a temperature of the vehicle interior of the vehicle interior temperature sensor 113, and may transfer relevant signals to the controller 100.

The controller 100 may be implemented as one or more processors operated by a predetermined program, and the predetermined program may include a set of instructions for performing respective steps included in a control method of an air conditioning system according to an embodiment described later.

Accordingly, in a control method of a heat pump system for a vehicle according to an embodiment, the controller 100 may be configured for controlling the temperature of the battery 9 based on data detected by the data detecting unit 110 and at the same time, efficiently recollect the thermal energy generated at the battery 9, improving the heating efficiency.

Furthermore, in a control method of the heat pump system, the controller 100 may preferentially perform heating of the vehicle interior by using the maximum waste heat of the battery 9 in the usable region of the heat pump based on data detected by the data detecting unit 110, and by switching to a mode for cooling by using the coolant cooled at the radiator 5 or cooling by using the coolant heat-exchanged with the refrigerant depending on the temperature of the battery 9, the power consumption efficiency may be prevented from being lowered, and the overall heating performance may be improved.

For such a purpose, as shown in FIG. 3A and FIG. 3B, a control method of a heat pump system for a vehicle according to an embodiment may include a procedure (A), a procedure (B), a procedure (C), and a procedure (D).

In the exemplary embodiment, in the procedure (A), when a user operates a heating mode for heating the vehicle interior, the controller 100 may circulate the coolant to the electrical component 3 and the chiller 59, and determine whether the temperature of the battery 9 is higher than or equal to a first predetermined temperature based on data detected from the data detecting unit 110 while controlling an operation of the heat pump system 50.

The procedure (A) may include the following steps.

First, at step S1, when the user operates the heat pump system for heating the vehicle interior, the controller 100 may operate the heating mode.

As such, at step S2, the controller 100 may connect the electrical component 3 and the chiller 59 by using at least two lines through which the coolant flows, and control the operation of the heat pump system 50.

In more detail, the controller 100 may operate the valve module 10 so that the first line 11, the sixth line 16, and the fifth line 15 in the cooling apparatus 1 are interconnected.

Accordingly, the electrical component 3 and the chiller 59 may be interconnected by the first line 11, the sixth line 16, and the fifth line 15. In such a state, the controller 100 may operate the first water pump 10a so that the coolant is circulated along the first line 11, the sixth line 16, and the fifth line 15.

Simultaneously, the controller 100 may be configured for controlling the first expansion valve 55 to be closed so that the refrigerant is not supplied from the heat pump system 50 to the evaporator 56, and may be configured for controlling the second expansion valve 61 to be opened so that the unexpanded refrigerant is supplied to the chiller 59.

Furthermore, the controller 100 may be configured for controlling the third expansion valve 62 to be opened to perform expansion so that the expanded refrigerant may be supplied to the heat-exchanger 54, and may operate the compressor 52 at a maximum rotation speed (RPM).

That is, as described above, the controller 100 may be configured for controlling the operation of the heat pump system 50.

Accordingly, the high-temperature and high-pressure refrigerant compressed at the compressor 52 may flow along the refrigerant line 51 and pass through the internal condenser 53a. At the instant time, the opening/closing door 53b may be opened so that the ambient air including passed through the evaporator 56 is introduced into the internal condenser 53a.

As the first expansion valve 55 is closed by the control signal of the controller 100, the refrigerant may not be supplied to the first evaporator 56.

Here, the high-temperature refrigerant supplied to the internal condenser 53a may increase the temperature of the ambient air introduced into the HVAC module 12 passing through the internal condenser 53a. That is, the introduced ambient air may be converted to a high-temperature state while passing through the internal condenser 53a and then introduced into the vehicle interior, implementing heating of the vehicle interior.

As such, the refrigerant having passed through the internal condenser 53a may be expanded at the third expansion valve 62 while flowing along the refrigerant line 51, and then may be introduced into the heat-exchanger 54.

The heat-exchanger 54 may be supplied with the refrigerant expanded from the third expansion valve 61 and may recollect the ambient air heat while evaporating the supplied refrigerant through heat-exchange with the ambient air. In addition, the refrigerant evaporated at the heat-exchanger 54 may be introduced into the second expansion valve 61 along the refrigerant line 51 and the opened refrigerant connection line 58.

At the present time, the second expansion valve 61 may supply the refrigerant introduced by the control signal of the controller 100 to the chiller 59, without expansion. Accordingly, the refrigerant evaporated while passing through the heat-exchanger 54 may be introduced into the chiller 59.

Meanwhile, the coolant having its temperature increased by absorbing waste heat from the electrical component 3 while circulating along the first line 11, the sixth line 16, and the fifth line 15 may be supplied to the chiller 59.

At the present time, the chiller 59 may recollect the waste heat of the electrical component 3 from the coolant having its temperature increased through heat-exchange between the refrigerant and the coolant.

Through such operations, when heating of the vehicle interior is required, the heat pump system 50 may improve the heating efficiency by absorbing the ambient air heat at the heat-exchanger 54, and increasing the temperature of the refrigerant by using the waste heat of the electrical component 3.

Meanwhile, the refrigerant having passed through the chiller 59 may flow along the refrigerant connection line 58 and the refrigerant line 51, to be introduced into the accumulator 57. Furthermore, the refrigerant having passed through the accumulator 57 may repeatedly perform the above-described processes while being supplied to the compressor 52.

When the step S2 is completed, the controller 100 may be configured to determine whether the temperature of the battery 9 is higher than or equal to the first predetermined temperature based on data detected from the data detecting unit 110, at step S3.

Here, the first predetermined temperature may be 32° C.

At the step S3 of determining whether the temperature of the battery 9 is higher than or equal to the first predetermined temperature, when it is determined that the temperature of the battery 9 is higher than or equal to the first predetermined temperature (i.e., the condition is satisfied), the procedure (B) may be performed.

On the other hand, at the step S3 of determining whether the temperature of the battery 9 is higher than or equal to the first predetermined temperature, when it is determined that the temperature of the battery 9 is lower than the first predetermined temperature (i.e., when the condition is not satisfied), the method may return to the step S2 to connect the electrical component and the chiller, and control the operation of the heat pump system by using at least two lines through which the coolant flows.

In the exemplary embodiment, in the procedure (B), when it is determined through the procedure (A) that the temperature of the battery 9 is higher than or equal to the first predetermined temperature, the controller 100 may circulate the coolant to the battery 9 and the chiller 59, and while maintaining the heating mode, may determine the discharge pressure of the compressor 52, an amount of change in the discharge pressure of the compressor 52, and the vehicle internal temperature, to control an operation of the cooling fan 6 and the heat pump system 50.

The procedure (B) may include the following steps.

When it is determined that the temperature of the battery 9 is higher than or equal to the first predetermined temperature at the step S3 of determining whether the temperature of the battery 9 included in the procedure (A) is higher than or equal to the first predetermined temperature, the controller 100 may connect the battery 9 and the chiller 59 by using at least two lines through which the coolant flows, at step S4.

In more detail, the controller 100 may operate the valve module 10 so that the third line 13, the fifth line 15, and the seventh line 17 in the cooling apparatus 1 are interconnected.

Accordingly, the battery 9 and the chiller 59 may be interconnected by the third line 13, the fifth line 15, and the seventh line 17. In such a state, the controller 100 may operate the second water pump 10b so that the coolant is circulated along the third line 13, the fifth line 15, and the seventh line 17.

Simultaneously, the controller 100 may maintain the control of the heat pump system 50, the same as in the step S2.

That is, the high-temperature and high-pressure refrigerant compressed at the compressor 52 may flow along the refrigerant line 51 and pass through the internal condenser 53a. At this time, the opening/closing door 53b may be opened so that the ambient air having passed through the evaporator 56 is introduced into the internal condenser 53a.

As the first expansion valve 55 is closed by the control signal of the controller 100, the refrigerant may not be supplied to the first evaporator 56.

Here, the high-temperature refrigerant supplied to the internal condenser 53a may increase the temperature of the ambient air introduced into the HVAC module 12 passing through the internal condenser 53a. That is, the introduced ambient air may be converted to a high-temperature state while passing through the internal condenser 53a and then introduced into the vehicle interior, implementing heating of the vehicle interior.

As such, the refrigerant having passed through the internal condenser 53a may be expanded at the third expansion valve 62 while flowing along the refrigerant line 51, and then may be introduced into the heat-exchanger 54.

The heat-exchanger 54 may be supplied with the refrigerant expanded from the third expansion valve 61 and may recollect the ambient air heat while evaporating the supplied refrigerant through heat-exchange with the ambient air. Furthermore, the refrigerant evaporated at the heat-exchanger 54 may be introduced into the second expansion valve 61 along the refrigerant line 51 and the opened refrigerant connection line 58.

At the present time, the second expansion valve 61 may supply the refrigerant introduced by the control signal of the controller 100 to the chiller 59, without expansion. Accordingly, the refrigerant evaporated while passing through the heat-exchanger 54 may be introduced into the chiller 59.

Meanwhile, the coolant having its temperature increased by absorbing waste heat from the battery 9 while circulating sequentially along the third line 13, the seventh line 17, and the fifth line 15 may be supplied to the chiller 59.

At the present time, the chiller 59 may recollect the waste heat of the battery 9 from the coolant having its temperature increased through heat-exchange between the refrigerant and the coolant.

As such, when it is determined that the temperature of the battery 9 is higher than or equal to the first predetermined temperature while heating the vehicle interior, the heat pump system 50 may absorb the ambient air heat at the heat-exchanger 54, and increase the temperature of the refrigerant introduced into the HVAC module 12 by using the waste heat of the battery 9, improving the heating efficiency.

Meanwhile, the refrigerant having passed through the chiller 59 may flow along the refrigerant connection line 58 and the refrigerant line 51, to be introduced into the accumulator 57. Furthermore, the refrigerant having passed through the accumulator 57 may repeatedly perform the above-described processes while being supplied to the compressor 52.

As such, at step S5, the controller 100 may be configured to determine whether the discharge pressure of the compressor 52 is greater than a predetermined pressure based on data detected from the data detecting unit.

At the step S5 of determining whether the discharge pressure of the compressor 52 is greater than the predetermined pressure, when it is determined that the discharge pressure of the compressor 52 is greater than the predetermined pressure (i.e., the condition is satisfied), the controller 100 may increase an opening of the third expansion valve 62 operated to be opened to perform expansion, at step S6.

On the other hand, at the step S5 of determining whether the discharge pressure of the compressor 52 is greater than the predetermined pressure, when it is determined that the discharge pressure of the compressor 52 is smaller than the predetermined pressure (i.e., when the condition is not satisfied), the method may return to the step S4 to connect the battery and the chiller by using at least two lines through which the coolant flows.

In the exemplary embodiment, when the step S6 of increasing the opening of the third expansion valve 62 operated to be opened to perform expansion is completed, the controller 100 may be configured to determine whether the amount of change in the discharge pressure of the compressor 52 is greater than 0 based on data detected from the data detecting unit 110, at the step S6.

At the step S7 of determining whether the amount of change in the discharge pressure of the compressor 52 is greater than 0, when it is determined that the amount of change in the discharge pressure of the compressor 52 is greater than 0 (i.e., the condition is satisfied), the controller 100 may decrease a rotation speed of the compressor 52, at step S8, so that the pressure of the refrigerant discharged from the compressor 52 is lowered.

On the other hand, in the determining of whether the amount of change in the discharge pressure of the compressor 52 is greater than 0, when it is determined that the amount of change in the discharge pressure of the compressor 52 is smaller than 0 (i.e., when the condition is not satisfied), the method may return to the step S6 of increasing the opening of the third expansion valve 62 operated to be opened to perform expansion.

When the step S8 is completed, the controller 100 may be configured to determine whether the vehicle internal temperature is higher than a predetermined target temperature based on data detected from the data detecting unit 110, at step S9.

Here, the target temperature may be a the vehicle internal temperature set by the user.

At the step S8 of determining whether the vehicle internal temperature is higher than the target temperature, when it is determined that the vehicle internal temperature is higher than the target temperature (i.e., the condition is satisfied), the controller 100 may be configured for controlling the cooling fan 6 and control the heat pump system 50 so that the usage of the heat pump system 50 may be minimized, at step S10.

Here, the controller 100 may operate the compressor 52 at a minimum rotation speed, may decrease a rotation speed of the cooling fan 6, and may decrease a rotation speed of the second water pump 10b so that the flow rate of the coolant circulating through the battery 9 and the chiller 59 is decreased.

On the other hand, at the step S9 of determining whether the vehicle internal temperature is higher than the target temperature, when it is determined that the vehicle internal temperature is lower than the target temperature (i.e., when the condition is not satisfied), the method may return to the step S8 of decreasing the rotation speed of the compressor 52.

In the exemplary embodiment, when the S10step is completed, the controller 100 may perform the procedure (C).

In the procedure (C) after performing the procedure (B), the controller 100 may be configured to determine a temperature change amount of the battery 9, and may circulate the coolant to the radiator 5 and the battery 9.

The procedure (C) may include the following steps.

First, at step S11, the controller 100 may be configured to determine whether the temperature change amount of the battery 9 is higher than 0° C. based on data detected from the data detecting unit 110.

At the step of determining whether the temperature change amount of the battery 9 is higher than 0° C., when it is determined that the temperature change amount of the battery 9 is higher than 0° C. (i.e., the condition is satisfied), the controller 100 may connect the radiator 5 and the battery 9 by using at least two lines through which the coolant flows, at step S12.

In more detail, the controller 100 may operate the valve module 10 so that the first line 11, the second line 12, the third line 13, and the fourth line 14 in the cooling apparatus 1 are interconnected.

Accordingly, the radiator 5 and the battery 9 may be interconnected by the first line 11, the second line 12, the third line 13, and the fourth line 14. In such a state, the controller 100 may operate the first water pump 10a so that the coolant is circulated along the first line 11, the second line 12, the third line 13, and the fourth line 14.

Through such an operation, the battery 9 may be cooled as the coolant cooled at the radiator 5 is introduced.

Meanwhile, the heat pump system 50 may maintain the operation state controlled by the controller 100 at the step S10 described above.

On the other hand, at the step S11 of determining whether the temperature change amount of the battery 9 is higher than 0° C., when it is determined that the temperature change amount of the battery 9 is lower than 0° C. (i.e., when the condition is not satisfied), the method may return to the step S4 in the procedure (B) to connect the battery 9 and the chiller 59 by using at least two lines through which the coolant flows.

In addition, the controller 100 may perform when the S12 step is completed, the procedure (D).

In the exemplary embodiment, in the procedure (D) after performing the procedure (C), the controller 100 may be configured to determine whether the temperature of the battery 9 is higher than a second predetermined temperature based on data detected from the data detecting unit 110, to control the operation of the cooling fan 6 and the heat pump system 50 while circulating the coolant to the battery 9 and the chiller 59, may be configured to determine whether the temperature of the battery 9 is higher than a third predetermined temperature, to control the compressor 52, and may be configured to determine whether the temperature of the battery 9 is lower than the first predetermined temperature.

The procedure (D) may include the following steps.

First, at step S13, the controller 100 may be configured to determine whether the temperature of the battery 9 is higher than the second predetermined temperature based on data detected from the data detecting unit 110.

Here, the second predetermined temperature may be 36° C.

When it is determined that the temperature of the battery 9 is lower than the second predetermined temperature (i.e., when the condition is not satisfied) in the determining of whether the temperature of the battery 9 is higher than the second predetermined temperature, the method may return to the step S12 to connect the radiator 5 and the battery 9 by using at least two lines through which the coolant flows.

On the other hand, at the step S13 of determining whether the temperature of the battery 9 is higher than the second predetermined temperature, when it is determined that the temperature of the battery 9 is higher than the second predetermined temperature (i.e., the condition is satisfied), the controller 100 may connect the battery 9 and the chiller 59 by using at least two lines through which the coolant flows, and control the operation of the cooling fan 6 and the heat pump system 50, at step S14.

In more detail, the controller 100 may operate the valve module 10 so that the third line 13, the fifth line 15, and the seventh line 17 in the cooling apparatus 1 are interconnected.

Accordingly, the battery 9 and the chiller 59 may be interconnected by the third line 13, the fifth line 15, and the seventh line 17. In such a state, the controller 100 may operate the second water pump 10b so that the coolant is circulated along the third line 13, the fifth line 15, and the seventh line 17.

Simultaneously, the controller 100 may be configured for controlling the first expansion valve 55 to be closed so that the refrigerant is not supplied to the evaporator 56, and control the second expansion valve 61 to be opened to perform expansion so that the expanded refrigerant may be supplied to the chiller 59.

Furthermore, the controller 100 may be configured for controlling the third expansion valve 62 to be opened so that the unexpanded refrigerant is supplied to the heat-exchanger 54, and may increase the rotation speed of the cooling fan 6 introduced into the HVAC module 12.

That is, as described above, the controller 100 may be configured for controlling the operation of the heat pump system 50.

Accordingly, the high-temperature and high-pressure refrigerant compressed at the compressor 52 may flow along the refrigerant line 51 and pass through the internal condenser 53a. At the instant time, the opening/closing door 53b may be opened so that the ambient air including passed through the evaporator 56 is introduced into the internal condenser 53a.

As the first expansion valve 55 is closed by the control signal of the controller 100, the refrigerant may not be supplied to the first evaporator 56.

Here, the high-temperature refrigerant supplied to the internal condenser 53a may increase the temperature of the ambient air introduced into the HVAC module 12 passing through the internal condenser 53a. That is, the introduced ambient air may be converted to a high-temperature state while passing through the internal condenser 53a and then introduced into the vehicle interior, implementing heating of the vehicle interior.

As such, the refrigerant having passed through the internal condenser 53a may flow along the refrigerant line 51, and may be introduced into the heat-exchanger 54 in an unexpanded state by the third expansion valve 62.

The heat-exchanger 54 may be supplied with the unexpanded refrigerant from the third expansion valve 61 and may condense the supplied refrigerant through heat-exchange with the ambient air.

Furthermore, the refrigerant condensed at the heat-exchanger 54 may be introduced into the second expansion valve 61 along the refrigerant line 51 and the opened refrigerant connection line 58.

At the present time, the second expansion valve 61 may expand the introduced refrigerant by the control signal of the controller 100, and may supply the expanded refrigerant to the chiller 59. Accordingly, the expanded refrigerant may be introduced into the chiller 59.

Meanwhile, the coolant having passed through the battery 9 along the third line 13, the fifth line 15, and the seventh line 17 may be supplied to the chiller 59.

Here, the chiller 59 may cool the coolant through heat-exchange with the expanded refrigerant. The coolant cooled while passing through the chiller 59 may be introduced into the valve module 10 along the fifth line 15. Thereafter, the coolant may flow from the valve module 10 to the third line 13, to be supplied to the battery 9.

Through such an operation, the battery 9 may be efficiently cooled by the coolant heat-exchanged with the refrigerant at the chiller 59.

Meanwhile, the refrigerant having passed through the chiller 59 may flow along the refrigerant connection line 58 and the refrigerant line 51, to be introduced into the accumulator 57. Furthermore, the refrigerant having passed through the accumulator 57 may repeatedly perform the above-described processes while being supplied to the compressor 52.

When the S14 step is completed, the controller 100 may be configured to determine whether the temperature of the battery 9 is higher than the third predetermined temperature based on data detected from the data detecting unit 110, at step S15.

Here, the third predetermined temperature may be 42° C.

At the step S15 of determining whether the temperature of the battery 9 is higher than the third predetermined temperature, when it is determined that the temperature of the battery 9 is lower than the third predetermined temperature (i.e., when the condition is not satisfied), the method may return to the step S14 to connect the battery 9 and the chiller 59, and control the operation of the cooling fan 6 and the heat pump system 50 by using at least two lines through which the coolant flows.

On the other hand, at the step S15 of determining whether the temperature of the battery 9 is higher than the third predetermined temperature, when it is determined that the temperature of the battery 9 is higher than the third predetermined temperature (i.e., the condition is satisfied), the controller 100 may increase the rotation speed of the compressor 52 introduced into the HVAC module 12, at step S16.

As such, at step S17, the controller 100 may be configured to determine whether the temperature of the battery 9 is lower than the first predetermined temperature based on data detected from the data detecting unit 110.

At the step S17 of determining whether the temperature of the battery 9 is lower than the first predetermined temperature, when it is determined that the temperature of the battery 9 is higher than the first predetermined temperature (i.e., when the condition is not satisfied), the method may return to the step of increasing the rotation speed of the compressor 52 introduced into the HVAC module 12.

On the other hand, at the step S17 of determining whether the temperature of the battery 9 is lower than the first predetermined temperature, when it is determined that the temperature of the battery 9 is lower than the first predetermined temperature (i.e., the condition is satisfied), the controller 100 may terminate the control.

As such, while performing respective steps included in the procedures (A), (B), (C), and (D), the controller 100 may perform recollecting the waste heat, cooling by using the coolant cooled at the radiator 5, or cooling by using the coolant heat-exchanged with the refrigerant, depending on the detected temperature of the battery 9, so that the battery 9 may be operated in the optimal condition.

Therefore, as described above, according to a control method of a heat pump system for a vehicle according to an embodiment, the heating efficiency may be improved by efficiently recollecting the thermal energy generated at the battery 9 while controlling the temperature control of the battery 9.

Furthermore, according to the present disclosure, heating of the vehicle interior may be preferentially performed by using the maximum waste heat of the battery 9 in the usable region of the heat pump, and by switching to a cooling mode for cooling by using the coolant cooled at the radiator 5 or cooling by using the coolant heat-exchanged with the refrigerant depending on the temperature of the battery 9, the power consumption efficiency may be prevented from being lowered, and the overall heating performance may be improved.

Furthermore, according to the present disclosure, when switching, for cooling of the battery 9, from the heating mode to a mode for cooling by using the coolant heat-exchanged with the refrigerant, the mode switching is possible through the operation control of the second and third expansion valves 61 and 62 without stopping the operation of the compressor 52, thereby preventing occurrence of the delay time due to mode switching, and more efficiently managing the temperature of the battery 9.

Furthermore, according to the present disclosure, by efficiently adjusting the temperature of the battery 9, the optimal performance of the battery 9 may be achieved, and the overall travel distance of the vehicle may be increased through efficient management of the battery 9.

While the present disclosure has been described in connection with what is presently considered to be practical exemplary embodiments of the present disclosure, it is to be understood that the invention is not limited to the disclosed embodiments. On the other hand, it is directed to cover various modifications and equivalent arrangements included within the spirit and scope of the appended claims.

### DESCRIPTION OF SYMBOLS

1: cooling apparatus
3: electrical component
5: radiator
6: cooling fan
7: reservoir tank
9: battery
11, 12: first and second lines
13, 14: third and fourth lines
15, 16: fifth and sixth lines
17: seventh line
50: heat pump system
51: refrigerant line
52: compressor
53: HVAC module
54: heat-exchanger
55: first expansion valve
56: evaporator
57: accumulator
58: refrigerant connection line
59: chiller
61: second expansion valve
62: third expansion valve
100: controller
110: data detecting unit
111: battery temperature sensor
112: pressure sensor
113: vehicle internal temperature sensor

What is claimed is:

1. A control method of a heat pump system for a vehicle, the method comprising procedures of:
(A) based on that a user operates a heating mode for heating a vehicle interior, circulating, by a controller, a coolant to an electrical component and a chiller, and determining, by the controller, whether a temperature of a battery is higher than or equal to a first predetermined temperature based on data detected from a data detecting unit while controlling an operation of a heat pump system;
(B) when the controller concludes through the procedure (A) that the temperature of the battery is higher than or equal to the first predetermined temperature, determining, by the controller, a discharge pressure of a compressor, an amount of change in the discharge pressure of the compressor, and a vehicle internal temperature while circulating the coolant to the battery and the chiller and maintaining the heating mode, and controlling an operation of a cooling fan and the heat pump system;
(C) after performing the procedure (B), determining, by the controller, a temperature of a battery change amount, and circulating the coolant to a radiator and the battery; and
(D) after performing the procedure (C), controlling, by the controller, the operation of the cooling fan and the heat pump system while circulating the coolant to the battery and the chiller by determining whether the temperature of the battery is higher than a second predetermined temperature based on the data detected from the data detecting unit, and controlling the compressor by determining whether the temperature of the battery is higher than a third predetermined temperature, and determine whether the temperature of the battery is lower than the first predetermined temperature.

2. The control method of claim 1, wherein, wherein the procedure (A) comprises:
operating the heating mode by the controller, based on that the user operates the heat pump system for heating the vehicle interior;
connecting, by the controller, the electrical component and the chiller, and controlling the operation of the heat pump system by using at least two lines through which the coolant flows; and
determining, by the controller, whether the temperature of the battery is higher than or equal to the first predetermined temperature based on the data detected from the data detecting unit.

3. The control method of claim 2, wherein, wherein, in the connecting, by the controller, the electrical component and the chiller, and controlling the operation of the heat pump system by using at least two lines through which the coolant flows, the controller is configured to:
control a first expansion valve to be closed so that a refrigerant is not supplied to an evaporator;
control a second expansion valve to be opened so that the unexpanded refrigerant is supplied to the chiller;
control a third expansion valve to be opened to perform expansion so that the expanded refrigerant may be supplied to a heat-exchanger; and
operate the compressor at a maximum rotation speed (RPM).

4. The control method of claim 2, wherein, when the controller concludes that the temperature of the battery is lower than the first predetermined temperature in the determining of whether the temperature of the battery is higher than or equal to the first predetermined temperature, the method returns to the connecting the electrical component and the chiller, and controlling the operation of the heat pump system by using at least two lines through which the coolant flows.

5. The control method of claim 2, wherein, when the controller concludes that the temperature of the battery is higher than or equal to the first predetermined temperature in the determining of whether the temperature of the battery is higher than or equal to the first predetermined temperature, the procedure (B) is performed.

6. The control method of claim 2, wherein, wherein the procedure (B) comprises:
connecting, by the controller, the battery and the chiller by using at least two lines through which the coolant flows;
determining, by the controller, whether the discharge pressure of the compressor is greater than a predetermined pressure based on the data detected from the data detecting unit;
increasing, by the controller, an opening of a third expansion valve operated to be opened to perform expansion, when the controller concludes that the discharge pressure of the compressor is greater than the predetermined pressure in the determining of whether the discharge pressure of the compressor is greater than the predetermined pressure;
determining, by the controller, whether the amount of change in the discharge pressure of the compressor is greater than 0 based on the data detected from the data detecting unit;
decreasing, by the controller, a rotation speed of the compressor, when the controller concludes that the amount of change in the discharge pressure of the compressor is greater than 0 in the determining of whether the amount of change in the discharge pressure of the compressor is greater than 0;
determining, by the controller, whether the vehicle internal temperature is higher than a predetermined target temperature based on the data detected from the data detecting unit; and
controlling, by the controller, the cooling fan and controlling the heat pump system so that usage of the heat pump system can be minimized, when the controller concludes that the vehicle internal temperature is higher than the target temperature in the determining of whether the vehicle internal temperature is higher than the target temperature.

7. The control method of claim 6, wherein, when the controller concludes that the discharge pressure of the compressor is smaller than the predetermined pressure in the determining of whether the discharge pressure of the compressor is greater than the predetermined pressure,
the method returns to the connecting, by the controller, the battery and the chiller by using at least two lines through which the coolant flows.

8. The control method of claim 6, wherein, when the controller concludes that the amount of change in the discharge pressure of the compressor is smaller than 0 in the determining of whether the amount of change in the discharge pressure of the compressor is greater than 0,
the method returns to the increasing, by the controller, the opening of the third expansion valve operated to be opened to perform expansion.

9. The control method of claim 6, wherein, in the determining of whether the vehicle internal temperature is higher than the target temperature, when the controller concludes that the vehicle internal temperature is lower than the target temperature,
the method returns to the decreasing, by the controller, the rotation speed of the compressor.

10. The control method of claim 6, wherein, wherein, in the controlling, by the controller, the cooling fan and controlling the heat pump system so that the usage of the heat pump system can be minimized, the controller is configured to:
operate the compressor at a minimum rotation speed;
decrease a rotation speed of the cooling fan; and
decrease a rotation speed of a corresponding water pump so that a flow rate of the coolant circulating through the battery and the chiller is decreased.

11. The control method of claim 6, wherein, wherein the procedure (C) comprises:
determining, by the controller, whether the temperature of the battery change amount is higher than 0° C. based on the data detected from the data detecting unit; and
connecting, by the controller, the radiator and the battery by using at least two lines through which the coolant flows, when the controller concludes that the temperature of the battery change amount is higher than 0° C. in the determining of whether the temperature of the battery change amount is higher than 0° C.

12. The control method of claim 11, wherein, when the controller concludes that the temperature of the battery change amount is lower than 0° C. in the determining of whether the temperature change amount of a battery is higher than 0° C.,
the method returns to the connecting, by the controller, the battery and the chiller by using at least two lines through which the coolant flows, in the procedure (B).

13. The control method of claim 11, wherein, wherein the procedure (D) comprises:
determining, by the controller, whether the temperature of the battery is higher than the second predetermined temperature based on the data detected from the data detecting unit;
connecting, by the controller, the battery and the chiller, and controlling the operation of the cooling fan and the heat pump system by using at least two lines through which the coolant flows, when the controller concludes that the temperature of the battery is higher than the second predetermined temperature in the determining of whether the temperature of the battery is higher than the second predetermined temperature;
determining, by the controller, whether the temperature of the battery is higher than the third predetermined temperature based on the data detected from the data detecting unit;
increasing, by the controller, the rotation speed of the compressor introduced into a Heating, Ventilation, and Air Conditioning (HVAC) module, when the controller concludes that the temperature of the battery is higher than the third predetermined temperature in the determining of whether the temperature of the battery is higher than the third predetermined temperature;
determining, by the controller, whether the temperature of the battery is lower than the first predetermined temperature based on the data detected from the data detecting unit; and
terminating the control by the controller, when the controller concludes that the temperature of the battery is lower than the first predetermined temperature in the determining of whether the temperature of the battery is lower than the first predetermined temperature.

14. The control method of claim 13, wherein, when the controller concludes that the temperature of the battery is lower than the second predetermined temperature in the determining of whether the temperature of the battery is higher than the second predetermined temperature,
the method returns to the connecting, by the controller, the radiator and the battery by using at least two lines through which the coolant flows, in the procedure (C).

15. The control method of claim 13, wherein, in the connecting the battery and the chiller, and controlling the operation of the cooling fan and the heat pump system by using at least two lines through which the coolant flows, the controller is configured to:
control a first expansion valve to be closed so that the refrigerant is not supplied to an evaporator;
control a second expansion valve to be opened to perform expansion so that the expanded refrigerant can be supplied to the chiller;
control the third expansion valve to be opened so that the unexpanded refrigerant is supplied to a heat-exchanger; and
increase a rotation speed of the cooling fan.

16. The control method of claim 13, wherein, when the controller concludes that the temperature of the battery is lower than the third predetermined temperature in the determining of whether the temperature of the battery is higher than the third predetermined temperature,
the method returns to the connecting, by the controller, the battery and the chiller, and controlling the operation of the cooling fan and the heat pump system by using at least two lines through which the coolant flows.

17. The control method of claim 13, wherein, when the controller concludes that the temperature of the battery is higher than the first predetermined temperature in the determining of whether the temperature of the battery is lower than the first predetermined temperature,
the method returns to the increasing, by the controller, the rotation speed of the compressor introduced into the HVAC module.

18. The control method of claim 1, wherein, wherein the data detecting unit comprises:
a battery temperature sensor configured for measuring the temperature of the battery;
a pressure sensor configured for measuring a pressure of the refrigerant discharged from the compressor; and
a vehicle internal temperature sensor configured for measuring a temperature of the vehicle interior.

19. The control method of claim 1,
wherein the controller is electrically connected to the heat pump system, and
wherein the heat pump system comprises:
the compressor configured to compress an introduced refrigerant;
a HVAC module in which an internal condenser and an evaporator connected to the compressor through a refrigerant line are provided;
a heat-exchanger connected to the internal condenser through the refrigerant line, and configured to condense or evaporate the refrigerant supplied from the internal condenser by heat-exchanging with an air;
a first expansion valve provided on the refrigerant line between the heat-exchanger and the evaporator;
a refrigerant connection line disposed between the compressor and the evaporator and including a first end portion connected to the refrigerant line, and a second end portion connected to the refrigerant line between the heat-exchanger and the first expansion valve;
the chiller provided on the refrigerant connection line, and configured to heat-exchange the refrigerant introduced through the refrigerant connection line with the selectively introduced coolant to adjust a temperature of the coolant;
a second expansion valve provided on the refrigerant connection line at an upstream end portion of the chiller; and
a third expansion valve provided on the refrigerant line between the internal condenser and the heat-exchanger.

20. The control method of claim 1,
wherein the controller is electrically connected to a cooling apparatus configured to circulate the coolant, and
wherein the cooling apparatus comprises:
a valve module configured to control a flow direction of the internally introduced coolant;
a first line connected to the valve module to selectively flow the coolant, and on which the electrical component is provided;
a second line including a first end portion connected to the first line and a second end portion connected to the valve module to selectively flow the coolant, and on which the radiator is provided;
a third line connected to the valve module to selectively flow the coolant, and on which the battery is provided;
a fourth line including a first end portion connected to the valve module to selectively flow the coolant, and a second end portion connected to the third line;
a fifth line including a first end portion connected to the valve module to selectively flow the coolant, and including a second end portion at which the chiller is provided;
a sixth line including a first end portion connected to the first line at a position where the first line and the second line are connected, and a second end portion connected to the chiller to selectively flow the coolant; and
a seventh line including a first end portion connected to the third line at a position where the third line and the fourth line are connected, and a second end portion connected to the chiller to selectively flow the coolant.
